(19) United States
(12) Patent Application Publication
(10) Pub. No.: US 2026/0268075 A1
(43) Pub. Date: Sep. 10, 2026

(54) MACHINE LEARNING-BASED GENERATION OF DATA STRUCTURES CHARACTERIZING OFFERINGS OF MULTIPLE ENTITIES

(71) Applicant: Dell Products L.P., Round Rock, TX (US)

(72) Inventors: Pooja Mittal, Hyderabad (IN); Aditi Ghosh, Kolkata (IN)

(21) Appl. No.: 19/073,395

(22) Filed: Mar. 7, 2025

(51) Int. Cl. G06F 40/20; G06F 16/34

(52) U.S. Cl. CPC G06F 40/20; G06F 16/345

(57) ABSTRACT

An apparatus comprises at least one processing device configured to identify, by processing a first prompt utilizing a machine learning model that takes as input at least a portion of one or more entity-specific documents of a first entity, features associated with a first set of offerings of the first entity. The at least one processing device is also configured to generate a plurality of second prompts for determining whether the first set of offerings of the first entity and one or more additional sets of offerings of one or more additional entities provide respective ones of the identified features, and to determine, based on processing the plurality of second prompts utilizing the machine learning model, a plurality of answers. The at least one processing device is further configured to generate, based on processing a third prompt utilizing the machine learning model, a data structure combining the determined answers.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering.

### SUMMARY

Illustrative embodiments of the present disclosure provide techniques for machine learning-based generation of data structures characterizing offerings of multiple entities.

In one embodiment, an apparatus comprises at least one processing device comprising a processor coupled to a memory. The at least one processing device is configured to identify, by processing a first prompt utilizing at least one machine learning model that takes as input at least a portion of one or more entity-specific documents of a first entity, a set of features associated with a first set of one or more offerings of the first entity. The at least one processing device is also configured to generate a plurality of second prompts for determining whether the first set of one or more offerings of the first entity and one or more additional sets of one or more offerings of one or more additional entities provide respective ones of the identified set of features, and to determine, based at least in part on processing the plurality of second prompts utilizing the at least one machine learning model, a plurality of answers characterizing whether the first set of one or more offerings and the one or more additional sets of one or more offerings provide respective ones of the identified set of features. The at least one processing device is further configured to generate, based at least in part on processing a third prompt utilizing the at least one machine learning model, a data structure combining at least portions of the determined plurality of answers in a tabular format.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based generation of data structures characterizing offerings of multiple entities in an illustrative embodiment.

FIG. 2 is a flow diagram of an exemplary process for machine learning-based generation of data structures characterizing offerings of multiple entities in an illustrative embodiment.

FIG. 3 shows an example of a battlecard data structure in an illustrative embodiment.

FIG. 4 shows an example of an executive summary derived from a battlecard data structure in an illustrative embodiment.

FIG. 5 shows an example of a newsletter derived from at least one of one or more executive summaries and one or more battlecard data structures in an illustrative embodiment.

FIG. 6 shows a process for creation of competitive intelligence data structures in an illustrative embodiment.

FIG. 7 shows a process for automated creation of competitive intelligence data structures in an illustrative embodiment.

FIGS. 8A-8D show example views of an interface of a competitive intelligence analysis tool in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

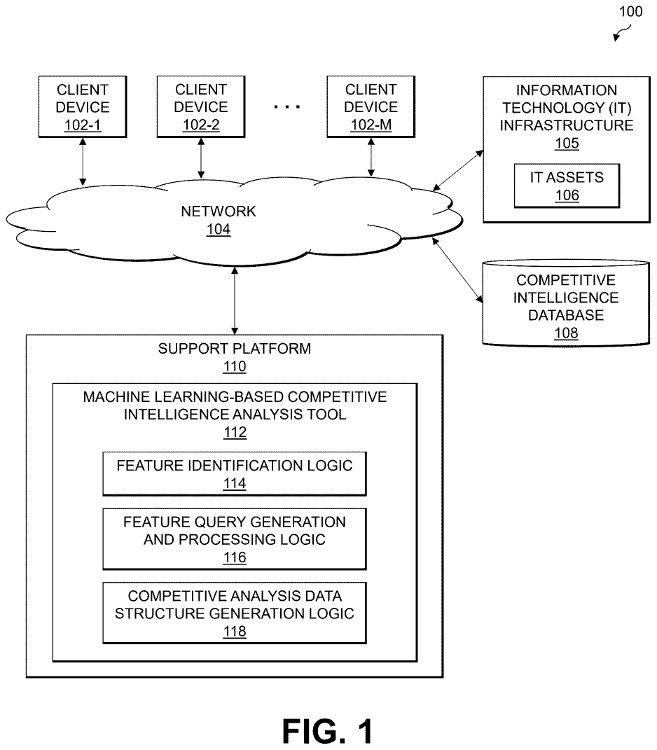

FIG. 1 shows an information processing system 100 configured in accordance with an illustrative embodiment. The information processing system 100 is assumed to be built on at least one processing platform and provides functionality for machine learning-based generation of data structures characterizing offerings of multiple entities. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a competitive intelligence (CI) database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for performing CI analysis (e.g., for one or more products or services offered by multiple service providers or other entities). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The CI database 108 is configured to store and record various information that is utilized by the support platform 110. Such information may include, for example, artificial intelligence (AI) and machine learning (ML) models used for performing CI analysis, including AI/ML models such as Large Language Models (LLMs), Retrieval-Augmented Generation (RAG) processing, etc., CI information and data structures produced through CI analysis, documents and other data sources containing information utilized for CI analysis, etc. The CI database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform CI analysis for an enterprise, organization or other entity. In some embodiments, the client devices 102 are utilized by members of the same enterprise, organization or other entity that operates the support platform 110. In other embodiments, the client devices 102 are utilized by members of one or more enterprises, organizations or other entities different than the enterprise, organization or other entity that operates the support platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the CI database 108 and the support platform 110 regarding user prompts for CI analysis, including generation and revision of CI data structures (e.g., battlecards, executive summaries, newsletters), implementation of a CI chatbot allowing user prompts to consume CI analysis information, etc. It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements a machine learning-based CI analysis tool 112. The machine learning-based CI analysis tool 112 comprises feature identification logic 114, feature query generation and processing logic 116, and competitive analysis data structure generation logic 118. The machine learning-based CI analysis tool 112 is configured to receive a request to perform CI analysis for one or more offerings (e.g., products, services, etc.) of a given entity against one or more offerings of additional entities that are identified as competitors for the given entity. The feature identification logic 114 is configured to identify, by processing a first prompt utilizing at least one ML model (e.g., an LLM) that takes as input at least a portion of one or more entity-specific documents of the given entity, a set of features associated with the offerings of the given entity. The feature query generation and processing logic 116 is configured to generate a plurality of second prompts for determining whether the offerings of the given entity and offerings of the additional entities provide respective ones of the identified set of features. The feature query generation and processing logic 116 is also configured to determine, based at least in part on processing the plurality of second prompts utilizing the at least one ML model, a plurality of answers characterizing whether the offerings of the given entity and the offerings of the additional entities provide respective ones of the identified set of features. The competitive analysis data structure generation logic 118 is configured to generate, based at least in part on processing a third prompt utilizing the at least one ML model, a data structure combining at least portions of the determined plurality of answers in a tabular format (e.g., a battlecard). The competitive analysis data structure generation logic 118 may be further configured to generate, based at least in part on processing an additional prompt utilizing the at least one ML model, a natural language summary of content of the generated data structure and/or a natural language summary of one or more changes in at least one of the offerings of the given entity and the offerings of the additional entities. The competitive analysis data structure generation logic 118 may be further configured to maintain a knowledge repository of competitive analysis information, the knowledge repository comprising the generated data structure and one or more additional data structures derived from the generated data structure, and to utilize the knowledge repository in processing, by the at least one ML model, one or more additional prompts to implement a ML chatbot.

At least portions of the machine learning-based CI analysis tool 112, the feature identification logic 114, the feature query generation and processing logic 116, and the competitive analysis data structure generation logic 118 may be implemented at least in part in the form of software that is stored in memory and executed by a processor.

It is to be appreciated that the particular arrangement of the client devices 102, the IT infrastructure 105, the CI database 108 and the support platform 110 illustrated in the FIG. 1 embodiment is presented by way of example only, and alternative arrangements can be used in other embodiments. As discussed above, for example, the support platform 110 (or portions of components thereof, such as one or more of the machine learning-based CI analysis tool 112, the feature identification logic 114, the feature query generation and processing logic 116, and the competitive analysis data structure generation logic 118) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the CI database 108 and the support platform 110 or components thereof (e.g., the machine learning-based CI analysis tool 112, the feature identification logic 114, the feature query generation and processing logic 116, and the competitive analysis data structure generation logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the CI database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the CI database 108 and the support platform 110, or portions or components thereof, to reside in different data centers. Numerous other distributed implementations are possible. The support platform 110 can also be implemented in a distributed manner across multiple data centers.

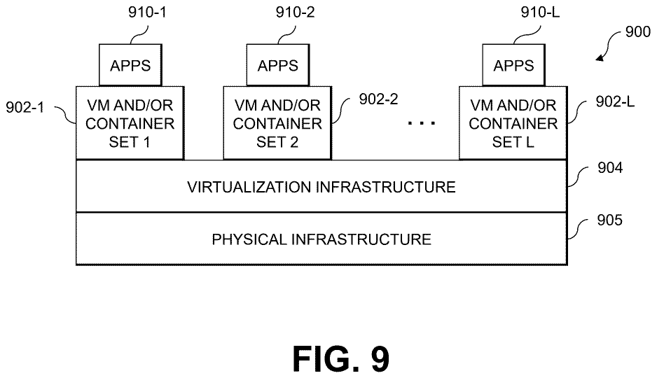

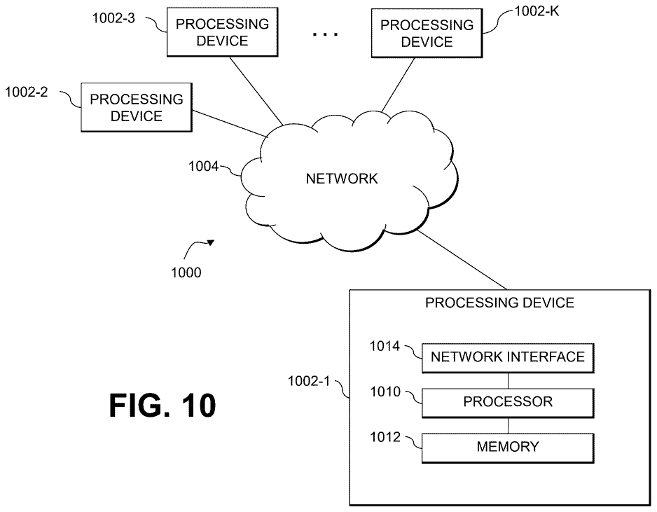

Additional examples of processing platforms utilized to implement the support platform 110 and other components of the information processing system 100 in illustrative embodiments will be described in more detail below in conjunction with FIGS. 9 and 10.

It is to be understood that the particular set of elements shown in FIG. 1 for ML-based generation of data structures characterizing offerings of multiple entities is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

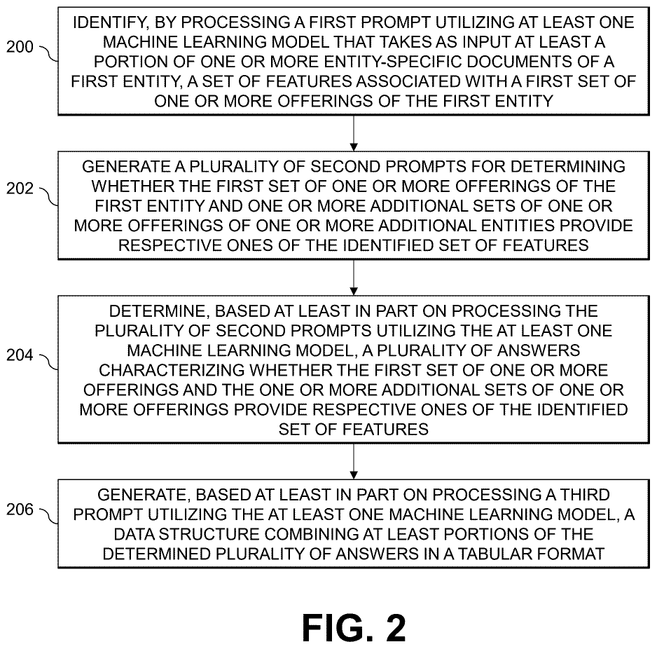

An exemplary process for ML-based generation of data structures characterizing offerings of multiple entities will now be described in more detail with reference to the flow diagram of FIG. 2. It is to be understood that this particular process is only an example, and that additional or alternative processes for ML-based generation of data structures characterizing offerings of multiple entities may be used in other embodiments.

In this embodiment, the process includes steps 200 through 206. These steps are assumed to be performed by the support platform 110 utilizing the machine learning-based CI analysis tool 112, the feature identification logic 114, the feature query generation and processing logic 116, and the competitive analysis data structure generation logic 118. The process begins with step 200, identifying, by processing a first prompt utilizing at least one ML model that takes as input at least a portion of one or more entity-specific documents of a first entity, a set of features associated with a first set of one or more offerings of the first entity. The at least one ML model may comprise an LLM.

In step 202, a plurality of second prompts are generated for determining whether the first set of one or more offerings of the first entity and one or more additional sets of one or more offerings of one or more additional entities provide respective ones of the identified set of features. The FIG. 2 process may further include receiving a specification of the one or more additional entities, utilizing a web crawler to identify a plurality of documents associated with the first set of one or more offerings of the first entity and the one or more additional sets of offerings of the one or more additional entities, and selecting at least a portion of at least a subset of the identified plurality of documents as context for RAG processing of the plurality of second prompts. The plurality of second prompts may comprise respective binary queries. The FIG. 2 process may further include, responsive to determining that a given one of the plurality of answers indicates that a given feature is not provided by at least one of the first set of one or more offerings of the first entity and the one or more additional sets of one or more offering of the one or more additional entities, to verify the given answer utilizing user-supplied feedback. At least a subset of the plurality of second prompts may be provided to at least one ML model in a batch.

In step 204, a plurality of answers characterizing whether the first set of one or more offerings and the one or more additional sets of one or more offerings provide respective ones of the identified set of features are determined based at least in part on processing the plurality of second prompts utilizing the at least one ML model.

In step 206, a data structure combining at least portions of the determined plurality of answers in a tabular format is generated based at least in part on processing a third prompt utilizing the at least one ML model. The generated data structure may comprise a competitive analysis battlecard. The FIG. 2 process may further include generating, based at least in part on processing an additional prompt utilizing the at least one ML model, a natural language summary of content of the generated data structure.

The FIG. 2 process may further include generating, based at least in part on processing an additional prompt utilizing the at least one ML model, a natural language summary of one or more changes in at least one of the first set of one or more offerings of the first entity and the one or more additional sets of one or more offerings of the one or more additional entities. The additional prompt may take as input at least a portion of the generated data structure. The additional prompt may also or alternatively take as input at least a portion of a natural language summary of content of the generated data structure produced utilizing the at least one ML model.

In some embodiments, the FIG. 2 process further includes maintaining a knowledge repository of competitive analysis information, the knowledge repository comprising the generated data structure and one or more additional data structures derived from the generated data structure, and utilizing the knowledge repository in processing, by the at least one ML model, one or more additional prompts to implement a ML chatbot. The one or more additional data structures may comprise a natural language summary of content of the generated data structure and/or a natural language summary of one or more changes in at least one of the first set of one or more offerings of the first entity and the one or more additional sets of one or more offering of the one or more additional entities.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from a ML model. It should further be appreciated that “generating” a data structure may encompass, for example, populating a previously-created data structure.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

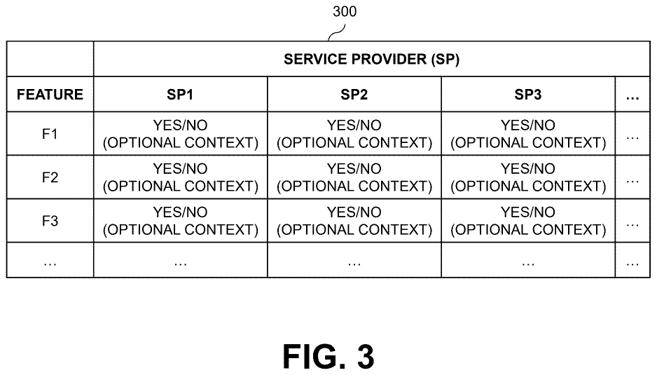

Insights and information provided by CI analysts are crucial for product development managers and teams to take product-level decisions and understand an organization, enterprise or other entity's positioning in a competitive market. One of the building blocks of any CI study is the use of battlecards. A battlecard is a complex industry-standard document which is generally in a tabular format, giving a detailed comparison between an entity and its competitors on any given service or software/hardware asset offering based on multiple features. A battlecard can be very comprehensive and difficult to digest, depending on the number of features being analyzed, the complexity of the service or software/hardware asset offering, etc. FIG. 3 shows an example of a battlecard data structure 300, which provides a visual aid in a tabular format delivering knowledge about a set of products, services or other offerings by multiple service providers or other entities. In the battlecard data structure 300, there are a set of features (F1, F2, F3, . . . ) and a set of service providers (SP1, SP2, SP3, . . . ). Each element in the battlecard data structure 300 may indicate whether a particular feature is offered by a particular service provider (e.g., yes/no indicators) and/or optional context about that feature offered by that service provider (e.g., whether or not a service or feature is provided, whether a service or feature is optional, descriptions of the service or feature provided, etc.).

Consider, for example, a battlecard data structure created to analyze an entity's accidental damage service offering (e.g., for computing devices such as laptops manufactured or sold by that entity). A product management team might want to know for which features that the entity is at an advantage or disadvantage relative to its competitors. Thus, to create this battlecard data structure, a number of features to be analyzed need to be defined. The features may include, for example, purchase window, repair limit, deductibles, service delivery, international coverage, subscription pricing, theft coverage, etc. For each of these features, in a conventional approach, a manual check is performed to determine whether the entity and each of its competitors provide capabilities for that feature or not. For example, some service providers or entities may charge a claim fee for accidental damage services, while others do not. As another example, each service provider may have multiple offerings for different warranty types or customer types, with those offerings having different values for a particular feature such as the repair limit (e.g., a number of repairs within a contract year, a percentage amount of repair costs covered over a specified term, up to the value of hardware, unlimited, etc.). Thus, the battlecard can represent a “battle” among different service providers or entities, indicating which service providers or entities “win” or “lose” each feature.

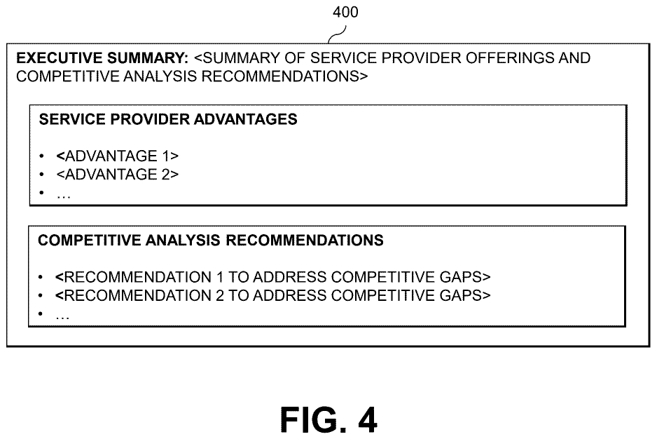

In addition to creation of battlecard data structures, CI analysis may include generation of executive summaries (e.g., high-level snapshots of the strengths and weaknesses of different service providers or other entities with respect to a particular type of offering, such as accidental damage services). FIG. 4 shows an example executive summary data structure 400, which may include a summarization of the results in a battlecard data structure. The executive summary data structure 400 may include a short natural language summary of a service provider or other entity's offerings and competitive analysis recommendations, as well as natural language descriptions of that service provider or other entity's advantages and competitive analysis recommendations (e.g., for addressing competitive gaps relative to other service providers or entities).

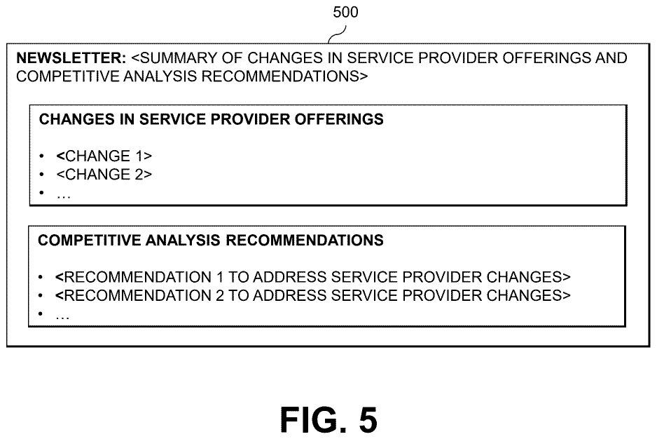

CI analysis may further include insight generation in the form of CI newsletters. CI analysts may work on spotting key trends in the market, and rollout CI newsletters at a regular schedule (e.g., weekly, monthly, bimonthly, etc.). CI newsletters may be used to track changes in offerings by a service provider or other entity's competitors. CI newsletters may be in the form of decentralized pieces of information stored in a mailbox (e.g., an email mailbox). FIG. 5 shows an example CI newsletter data structure 500, which includes a short natural language summary of changes in service provider offerings and competitive analysis recommendations, as well as natural language descriptions of the changes in service provider or other entity offerings and competitive analysis recommendations (e.g., to address changes in offerings by a service provider or other entity's competitors). CI newsletters are typically not stored or maintained together and thus conventionally are not able to be used effectively to convey any cumulative insight.

In conventional approaches, the entire landscape of CI analysis (e.g., from battlecard creation, to executive summary generation and insight generation from newsletters) requires significant manual effort, which is not only time-consuming but also prone to inconsistencies and errors, and results in difficult to digest content. For example, CI analysis may require CI analysts to do extensive searches of various data sources (e.g., Internet sources including service provider or other entity websites, marketing documents, legal documents, etc.). Illustrative embodiments provide technical solutions for leveraging AI/ML techniques for automated CI analysis, including the generation of various CI data structures (e.g., battlecards, executive summaries and newsletters). Further, the technical solutions in some embodiments provide an AI/ML chatbot that is configured to provide meaningful insights (e.g., from a repository of CI data structures, including battlecards, executive summaries and/or newsletters) in a user-friendly conversational way.

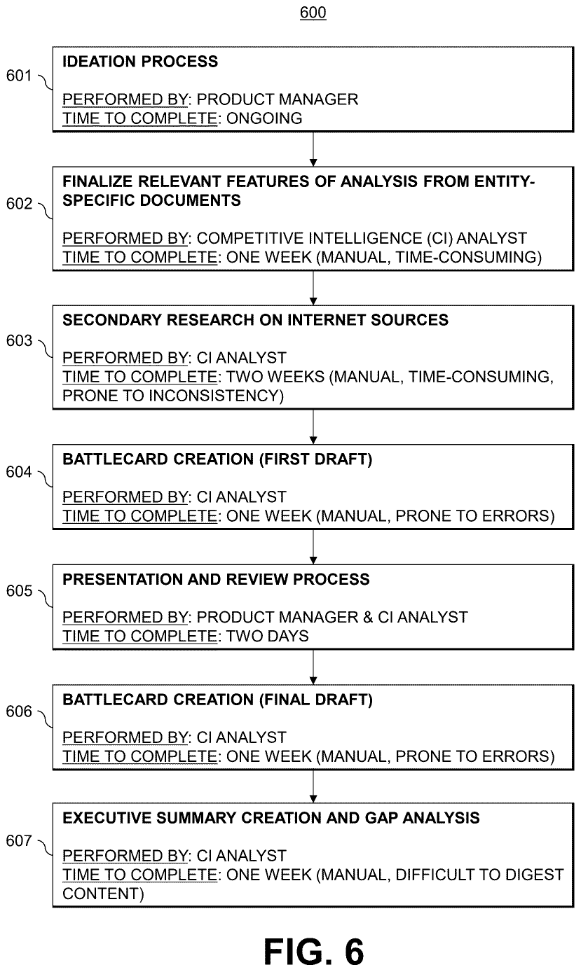

FIG. 6 shows a process flow 600 for CI analysis, which includes various stages performed by different users or teams within an entity (e.g., product managers, CI analysts, etc.), and which may be associated with different typical or expected times to complete. The stages of the CI analysis process flow 600 include:
Stage 601 (Ideation): an ideation process is performed by product managers, which is an ongoing process whereby the product managers determine to perform CI analysis for a particular product type or offering of an entity;
Stage 602 (Feature Identification): CI analysts identify and determine relevant features for the CI analysis of the product type or offering of the entity (e.g., through analysis of entity-specific documents relating to that product type or offering);
Stage 603 (Secondary Research): CI analysts perform secondary research (e.g., on Internet or other sources) to analyze products and offerings of competitors for the features identified in stage 602;
Stage 604 (Battlecard Generation); CI analysts generate a “first draft” battlecard data structure based on the results of stages 602 and 603;
Stage 605 (Presentation and Review); the product managers and CI analysis meet and review the first draft battlecard data structure generated in stage 604, and determine any changes and revisions needed;
Stage 606 (Battlecard Revision); CI analysts generate a “final draft” battlecard data structure by implementing the changes and revisions determined in stage 605 to the “first draft” battlecard data structure generated in stage 604; and
Stage 607 (Executive Summary Creation and Gap Analysis); CI analysts generate executive summary and newsletter data structures based on the “final draft” battlecard data structure generated in stage 606 to determine gaps and CI recommendations for addressing the same.

The stages 601-607 of the CI analysis process 600 are all highly manual processes, which as indicated in FIG. 6 require varying estimated times to compete, and are subject to various disadvantages resulting from the manual processes performed in the different stages 601 through 607 (e.g., time-consuming, prone to inconsistency and/or error, produces difficult to digest content, etc.). The entire CI analysis process 600 shown in FIG. 6 can take 6+ weeks for a CI analyst for a single CI project. The technical solutions described herein provide tools which can aid in various of these stages (e.g., at least stages 602, 603, 604, 606 and 607) and eliminate almost all manual effort, greatly reducing the time required for the CI analysis process 600. For example, use of the technical solutions described herein can save 4+ weeks per CI analyst per CI project (e.g., a greater than 70% reduction in manual work), which can free CI analysts to invest in more innovative tasks. Further, the technical solutions described herein are highly scalable, and can be deployed across multiple teams in a large enterprise or other entity. Further, the technical solutions described herein in some embodiments are configured to maintain a repository of CI data structures (e.g., battlecards, executive summaries and/or newsletters), and implement an AI/ML chatbot tool that provides a user-friendly interface for spotting key trends shaping an industry and relevant best practices in a conversational way.

The technical solutions described herein, in some embodiments, provide a holistic end-to-end solution for CI analysis, providing a helpful AI/ML-based tool that aids CI analysts and other users to generate and consume CI content. The CI analysis tools described herein can aid in creation of battlecard data structures, through enabling use of AI/ML to streamline various parts of a CI analysis process (e.g., CI analysis process 600 shown in FIG. 6). For example, the CI analysis tools described herein are able to automate the identification of themes and features from submitted entity-specific documents utilizing an LLM. Further, based on provided final features and names or other identifiers of competitors, the CI analysis tools described herein are able to generate meta-tags for automating secondary research (e.g., on Internet or other data sources). Further, the CI analysis tools described herein make the “first draft” battlecard data structure readily available, through automatic firing of binary questions generated in earlier steps against a refreshed knowledge repository post web scraping. CI analysts can then get the first draft battlecard data structure reviewed and create a final draft battlecard data structure utilizing the CI analysis tools described herein. The CI analysis tools described herein can further generate executive summaries based on the created battlecard data structures. It should be noted that review and feedback from human experts may be incorporated at various steps, to make sure that the machine and human intelligence work together for faster and improved outcomes.

The CI analysis tools described herein may maintain a knowledge repository (e.g., of Market Intelligence (MI) data) including information generated by the CI analysis tools and CI teams within an entity, as well as entity-specific and competitor documents. The CI analysis tools described herein can be used to spot key trends shaping an industry and relevant best practices, and leverage the knowledge repository via an AI/ML chatbot allowing users such as CI analysts to consume the data in a conversational way. In some embodiments, RAG processing is leveraged along with an LLM for the generation of CI data structures and production of responses in the AI/ML chatbot.

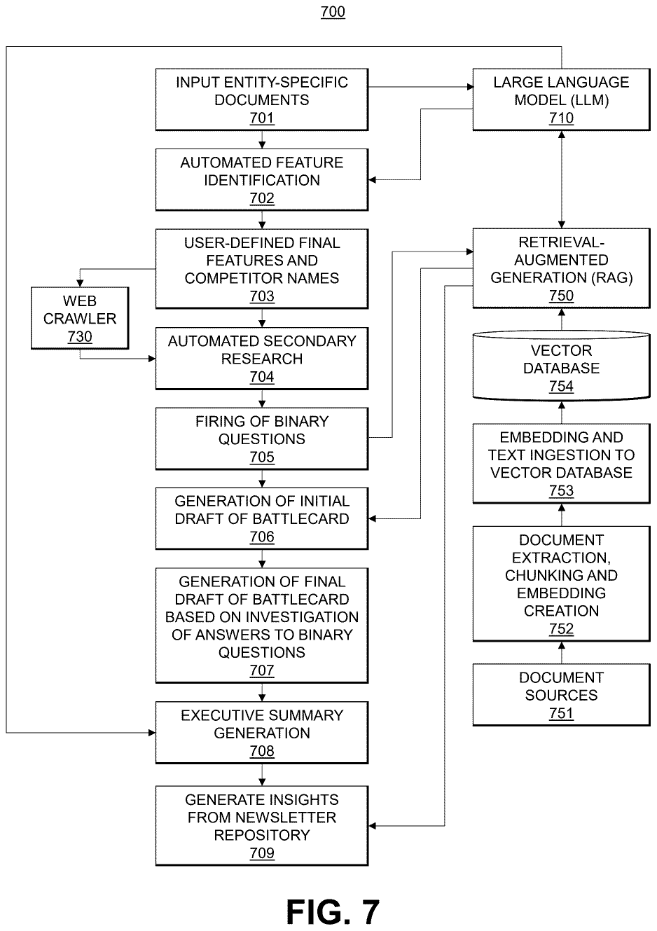

FIG. 7 shows a process flow 700 implemented utilizing a CI analysis tool which leverages AI/ML for CI analysis. In the process flow 700, as a first step, a user (e.g., a CI analyst) inputs one or more entity-specific documents for study in block 701. These documents are taken as input for making an initial call to LLM 710, where the entity-specific documents are provided as context to prompt the LLM 710 to generate a top set of themes or features from the provided entity-specific documents. The LLM 710 produces a set of machine-generated features used for automated feature identification in block 702. The machine-generated features are then provided or output to the user, who can review/edit and possibly add new features that the user determines are missing from the machine-generated features to generate a final set of features in block 703. In block 703, a set of identifiers for one or more competitors (e.g., competitor names) are also input. The way in which machine and human intelligence work together in a loop provides various technical advantages, where the machine output of the LLM 710 serves as an improved starting point for human expert review that serves as quality assurance for the machine output. The process flow 700 leverages entity-specific documents which are input in block 701 as a source of information that is passed to the LLM 710 to determine the key features for comparative study between an entity and its competitors. This provides a novel approach for automating the feature set that is used in CI data structures such as battlecards, which provides improvements relative to conventional approaches that rely on manual and time-consuming effort by CI analysts.

The final feature set and competitor names determined in block 703 are provided to a web crawler 730 which can search Internet or other sources for automated secondary research in block 704. This automated secondary research may identify various documents to be used as document sources 751. In block 752, documents from the document sources 751 are extracted, chunked and embedded. Embedding and text ingestion is then performed in block 753 to populate a vector database 754 that is utilized by RAG processing 750. In block 705, automatic triggering of binary questions, which is described in further detail below, is performed against the collected information in the vector database 754 utilizing the RAG processing 750 and LLM 710. The results of such binary questions provides responses required for generation of an initial draft of a battlecard data structure in block 706. This approach of using generative binary questions coupled with RAG processing 750 to capture key features of competitors provides various technical advantages. A sample part of the first draft battlecard data structure produced in block 706 may include simple yes/no answers for whether particular service providers (e.g., the entity and its competitors) do or do not offer particular features (e.g., a single point of contact, Original Equipment Manufacturer (OEM) shipping options, an online customer portal, etc.). If the required documents are provided as input and the LLM 710 is asked to generate a comparative study in a single prompt, this is a very complex problem for the LLM 710 to solve and therefore the accuracy of the generated output would be very low. Instead of asking one “hard” question to the LLM 710, the technical solutions in some embodiments break this hard problem down into multiple comparatively easy binary problems which the LLM 710 can handle very efficiently. One binary question or LLM prompt can be generated for each feature and each service provider (e.g., “does service provider offer feature “F”, answer in yes or no”). The responses of all these binary questions are then combined and passed through another call to the LLM 710 to organize and provide the first draft battlecard data structure in block 706 (e.g., in a tabular format such as that shown in FIG. 3). The technique of systematically breaking down the hard problem into multiple easy problems (e.g., the binary questions for each service provider and feature), and then combining the responses to create the final complex output (e.g., the initial battlecard data structure) provides technical advantages.

The process flow 700 continues in block 707 with generation of a “final” battlecard data structure, based on investigation of the answers to the binary questions (e.g., which may supplement the yes/no answers with additional context as discussed elsewhere herein, correct any erroneous yes/no answers, etc.). The final battlecard data structure generated in block 707 may be used for generation of executive summaries in block 708. Insights in the form of newsletters may be generated and maintained in a repository of CI data structures (e.g., possibly along with the battlecard and/or executive summary data structures) in block 709. This repository is used as a source of information for an AI/ML chatbot, which takes user inputs, and forms prompts to LLM 710 utilizing RAG processing 750 (e.g., to obtain relevant information from the repository as context for the prompts) to generate answers to the prompts provided as output of the AI/ML chatbot.

The technical solutions described herein provide CI analysis tools which leverage technologies such as web crawlers, AI/ML techniques including LLM with RAG processing, etc., and combine these and other technologies to automate the generation of CI data structures (e.g., automated generation of good quality features for battlecards, generation of battlecards, generation of executive summaries and newsletters derived in part from the battlecards, etc., through automated triggering of generative binary questions). The technical solutions described herein are thus able to replace a lot of manual effort, which in turn frees up productive hours for CI analysts to utilize in more innovative tasks.

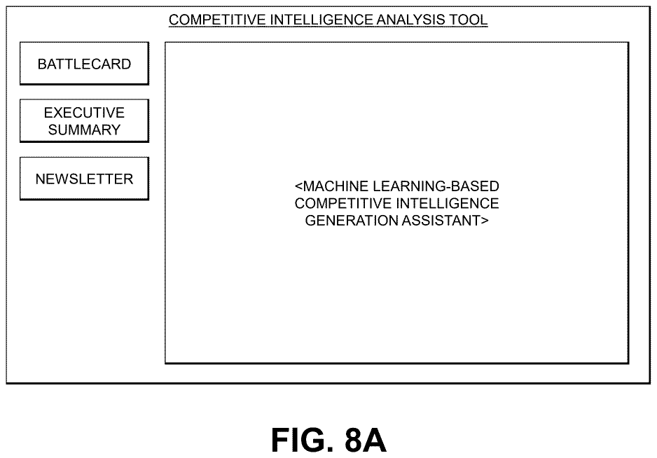

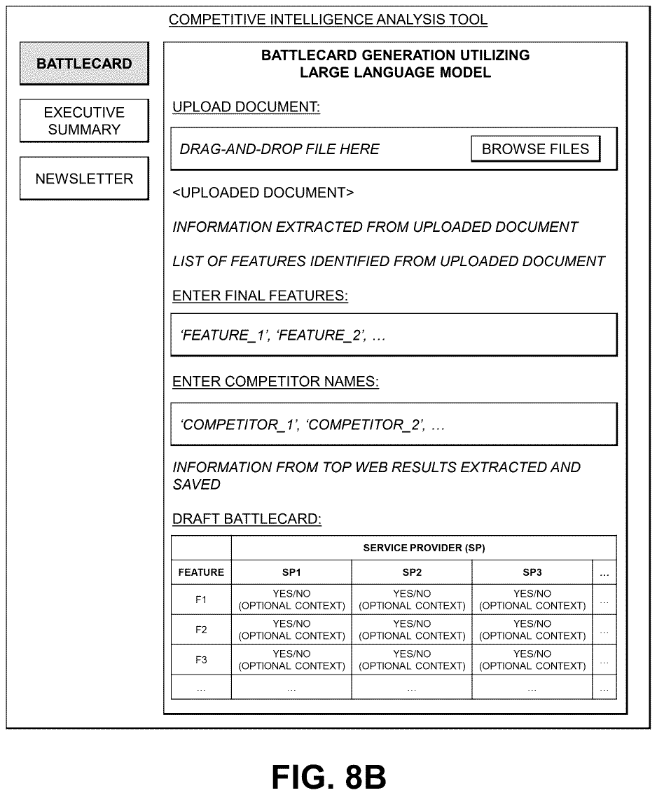

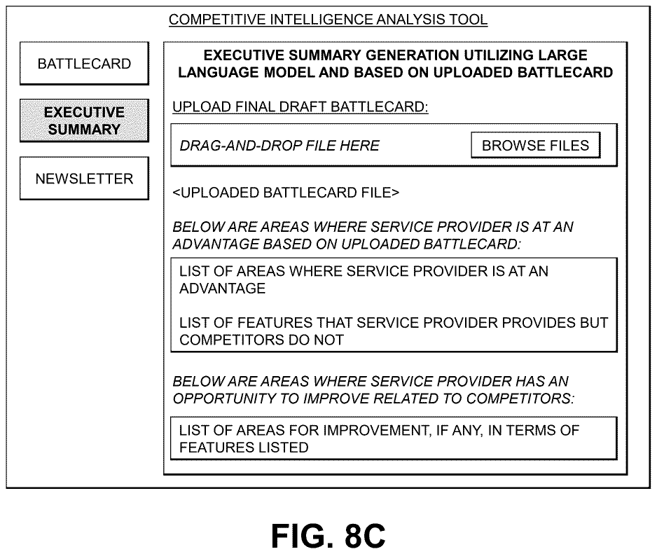

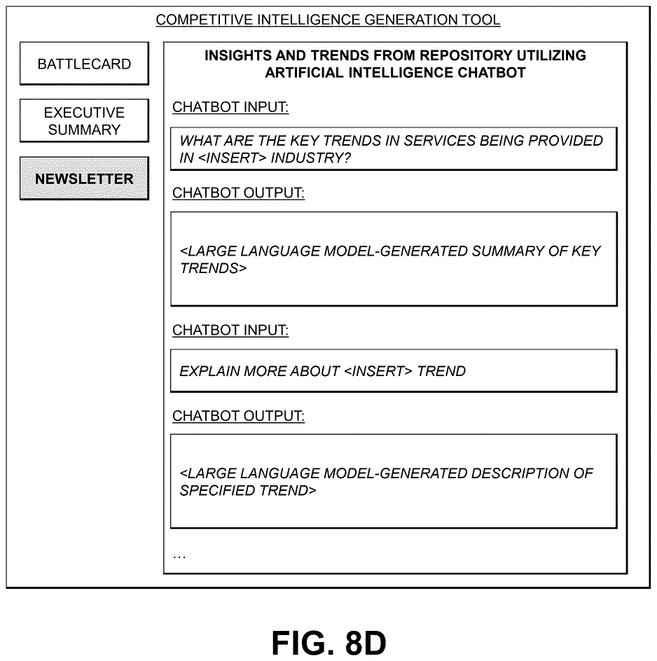

An example implementation will now be described with respect to FIGS. 8A-8D, which show respective views of an interface provided by a CI analysis tool. FIG. 8A shows an initial view of the CI analysis tool, which provides an AI/ML-based CI generation assistant with options for generation of different types of CI data structures including battlecards, executive summaries and newsletters.

Battlecard generation is illustrated in the interface view shown in FIG. 8B. First, a user (e.g., a CI analyst) inputs one or more entity-specific documents for an area of study for CI analysis. The submitted entity-specific documents are taken as input by a first LLM call, where the entity-specific documents are scanned through to generate automatic features for further study. For example, a user may provide one or more entity-specific documents on an “Asset Recovery Service” as an input, from which an LLM generates a top set of features (e.g., 15, or some other configured number) from the submitted entity-specific documents: (1) asset recovery; (2) sustainability; (3) data security; (4) logistics management; (5) value recovery; (6) e-waste recycling; (7) real-time reporting; (8) personalized environmental impact reporting; (9) asset appraisal; (10) multi-vendor management; (11) compliance expertise; (12) onsite data sanitization; (13) onsite hard drive shredding; (14) centralized online portal; and (15) IT lifecycle management. These generated features are provided to the user, who can review the generated features, edit/add the generated features, and potentially add new features that the user thinks are important for the study but are missing from the machine-generated LLM output. This combines machine and human intelligence to work in a loop and ensure good quality output. In this example, the following set of final features is utilized: (1) service representative as a single point of contact; (2) OEM transportation of devices/equipment options; (3) online dashboard; (4) unit minimums; (5) onsite/offsite data sanitization; (6) donation option; (7) environmental report or certificate; (8) no upfront fee; (9) multi-vendor; (10) asset value appraisal/assessment; (11) alignment with/conformance to designated standards; (12) recycling according to environmental compliance; and (13) fund innovation/new device purchase.

The CI analysis tool then asks the user to provide competitor names or other identifiers, around which the study is to be done. Based on the provided finalized features and competitor names, the CI analysis tool generates metatags for passing to a web crawler. The web crawler scans through one or more data sources, based on the provided metatags, to extract information for the competitors and save the collected information at a specified location. In some embodiments, this includes automated secondary research on the Internet, though other data sources may also or alternatively be used. The extracted information from the Internet and/or other data sources, as well as information from the input entity-specific documents, are chunked, embedded and stored in a vector database. Triggering of automatically generated binary questions then starts, where binary questions are asked one at a time (e.g., in separate LLM calls, which may be performed at least partially in parallel with one another) and the responses are collected for generating a first draft battlecard data structure utilizing RAG processing. Example binary questions include, for example: “Does <Service Provider 1> provide an online dashboard?”, “Does <Service Provider 2> provide an online dashboard?”, “Does <Service Provider 3> provide an online dashboard?”, “Does <Service Provider 1> provide a single point of contact?”, “Does <Service Provider 2> provide a single point of contact?”, “Does <Service Provider 3> provide a single point of contact?”, etc. Once all the responses to the binary questions are generated, the results are passed through another LLM call to organize the information in a tabular format.

The CI analysis tool allows the user to download the draft battlecard data structure, and to work on a final draft based at least in part on product manager review. It is observed that almost all the “yes” answers provided as results for the binary questions are accurate, since the tool was able to find that information in the provided documents. Further investigation is needed for the “no” answers, as they may be inaccurate due to the required information being missing from the CI knowledge repository and/or the wording of the feature being different than the wording used in one or more documents or sources in the CI knowledge repository. Once the final draft battlecard data structure is ready, it can be submitted to the CI analysis tool.

FIG. 8C shows an interface view of executive summary data structure generation, which may be based on the “final” or submitted battlecard data structure. The CI analysis tool makes another LLM call to generate an executive summary from the submitted battlecard data structure.

FIG. 8D shows an interface view of newsletter data structure generation and implementation of an AI/ML chatbot allowing user querying of generated CI newsletters and other data structures (e.g., including executive summaries and/or battlecards). The user is provided with the ability to ask natural language questions to the AI/ML chatbot, which utilizes an LLM to get insights from the CI analysis data repository and understand key market trends in a conversational way.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for ML-based generation of data structures characterizing offerings of multiple entities will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100 in FIG. 1. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for ML-based generation of data structures characterizing offerings of multiple entities as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to identify, by processing a first prompt utilizing at least one machine learning model that takes as input at least a portion of one or more entity-specific documents of a first entity, a set of features associated with a first set of one or more offerings of the first entity;
to generate a plurality of second prompts for determining whether the first set of one or more offerings of the first entity and one or more additional sets of one or more offerings of one or more additional entities provide respective ones of the identified set of features;
to determine, based at least in part on processing the plurality of second prompts utilizing the at least one machine learning model, a plurality of answers characterizing whether the first set of one or more offerings and the one or more additional sets of one or more offerings provide respective ones of the identified set of features; and
to generate, based at least in part on processing a third prompt utilizing the at least one machine learning model, a data structure combining at least portions of the determined plurality of answers in a tabular format.

2. The apparatus of claim 1 wherein the at least one machine learning model comprises a large language model (LLM).

3. The apparatus of claim 1 wherein the at least one processing device is further configured:
to receive a specification of the one or more additional entities; and
to utilize a web crawler to identify a plurality of documents associated with the first set of one or more offerings of the first entity and the one or more additional sets of offerings of the one or more additional entities; and
to select at least a portion of at least a subset of the identified plurality of documents as context for retrieval-augmented generation processing of the plurality of second prompts.

4. The apparatus of claim 1 wherein the plurality of second prompts comprise respective binary queries.

5. The apparatus of claim 4 wherein the at least one processing device is further configured, responsive to determining that a given one of the plurality of answers indicates that a given feature is not provided by at least one of the first set of one or more offerings of the first entity and the one or more additional sets of one or more offering of the one or more additional entities, to verify the given answer utilizing user-supplied feedback.

6. The apparatus of claim 4 wherein at least a subset of the plurality of second prompts are provided to at least one machine learning model in a batch.

7. The apparatus of claim 1 wherein the generated data structure comprises a competitive analysis battlecard.

8. The apparatus of claim 1 wherein the at least one processing device is further configured to generate, based at least in part on processing an additional prompt utilizing the at least one machine learning model, a natural language summary of content of the generated data structure.

9. The apparatus of claim 1 wherein the at least one processing device is further configured to generate, based at least in part on processing an additional prompt utilizing the at least one machine learning model, a natural language summary of one or more changes in at least one of the first set of one or more offerings of the first entity and the one or more additional sets of one or more offering of the one or more additional entities.

10. The apparatus of claim 9 wherein the additional prompt takes as input at least a portion of the generated data structure.

11. The apparatus of claim 9 wherein the additional prompt takes as input at least a portion of a natural language summary of content of the generated data structure produced utilizing the at least one machine learning model.

12. The apparatus of claim 1 wherein the at least one processing device is further configured:
to maintain a knowledge repository of competitive analysis information, the knowledge repository comprising the generated data structure and one or more additional data structures derived from the generated data structure; and
to utilize the knowledge repository in processing, by the at least one machine learning model, one or more additional prompts to implement a machine learning chatbot.

13. The apparatus of claim 12 wherein the one or more additional data structures comprise a natural language summary of content of the generated data structure.

14. The apparatus of claim 12 wherein the one or more additional data structures comprise a natural language summary of one or more changes in at least one of the first set of one or more offerings of the first entity and the one or more additional sets of one or more offering of the one or more additional entities.

15. A computer program product comprising a non-transitory processor-readable storage medium having stored therein program code of one or more software programs, wherein the program code when executed by at least one processing device causes the at least one processing device:
to identify, by processing a first prompt utilizing at least one machine learning model that takes as input at least a portion of one or more entity-specific documents of a first entity, a set of features associated with a first set of one or more offerings of the first entity;
to generate a plurality of second prompts for determining whether the first set of one or more offerings of the first entity and one or more additional sets of one or more offerings of one or more additional entities provide respective ones of the identified set of features;
to determine, based at least in part on processing the plurality of second prompts utilizing the at least one machine learning model, a plurality of answers characterizing whether the first set of one or more offerings and the one or more additional sets of one or more offerings provide respective ones of the identified set of features; and
to generate, based at least in part on processing a third prompt utilizing the at least one machine learning model, a data structure combining at least portions of the determined plurality of answers in a tabular format.

16. The computer program product of claim 15 wherein the program code when executed by the at least one processing device further cause the at least one processing device to generate, based at least in part on processing an additional prompt utilizing the at least one machine learning model, a natural language summary of content of the generated data structure.

17. The computer program product of claim 15 wherein the program code when executed by the at least one processing device further cause the at least one processing device to generate, based at least in part on processing an additional prompt utilizing the at least one machine learning model, a natural language summary of one or more changes in at least one of the first set of one or more offerings of the first entity and the one or more additional sets of one or more offering of the one or more additional entities.

18. A method comprising:
identifying, by processing a first prompt utilizing at least one machine learning model that takes as input at least a portion of one or more entity-specific documents of a first entity, a set of features associated with a first set of one or more offerings of the first entity;
generating a plurality of second prompts for determining whether the first set of one or more offerings of the first entity and one or more additional sets of one or more offerings of one or more additional entities provide respective ones of the identified set of features;
determining, based at least in part on processing the plurality of second prompts utilizing the at least one machine learning model, a plurality of answers characterizing whether the first set of one or more offerings and the one or more additional sets of one or more offerings provide respective ones of the identified set of features; and
generating, based at least in part on processing a third prompt utilizing the at least one machine learning model, a data structure combining at least portions of the determined plurality of answers in a tabular format;
wherein the method is performed by at least one processing device comprising a processor coupled to a memory.

19. The method of claim 18 further comprising generating, based at least in part on processing an additional prompt utilizing the at least one machine learning model, a natural language summary of content of the generated data structure.

20. The method of claim 18 further comprising generating, based at least in part on processing an additional prompt utilizing the at least one machine learning model, a natural language summary of one or more changes in at least one of the first set of one or more offerings of the first entity and the one or more additional sets of one or more offering of the one or more additional entities.
